(19) United States
(12) Patent Application Publication
(10) Pub. No.: US 2014/0263344 A1
(43) Pub. Date: Sep. 18, 2014

(54) In-Frame Wire Fry Basket With Shortened, Corner-Protecting Wires

(71) Applicant: Archer Wire International Corporation, Bedford Park, IL (US)

(72) Inventors: Lawrence J. Svabek, Orland Park, IL (US); Leonard J. Svabek, Orland Park, IL (US); Richard J. Svabek, Lemont, IL (US)

(73) Assignee: ARCHER WIRE INTERNATIONAL CORPORATION, Bedford Park, IL (US)

(21) Appl. No.: 13/845,244

(22) Filed: Mar. 18, 2013

(51) Int. Cl. A47J 37/12

(52) U.S. Cl. CPC A47J 37/1295
USPC 220/485; 220/755

(57) ABSTRACT

A wire fry basket is made from an inverted, frusto-pyramidal-shaped wire-mesh basket having four, inclined wire mesh sides, a wire mesh bottom and an open top. The top edge of the wire mesh basket, inclined wire-mesh corners and its bottom, horizontally-oriented wire mesh corners are protected by a rigid wire frame. The inclined wire mesh corners formed by and between the wire mesh sides are only partially covered or protected by short, rigid wires that extend upwardly from the bottom wire frame. Using short, corner-protecting wires reduces the weight of the basket that would otherwise result from using full corner-length wires.

### BACKGROUND

Wire mesh baskets are used to dry fry food. Prior art wire fry baskets are comprised of three components: a relatively fine-mesh wire basket; a frame to which the mesh basket is attached and a handle by which the mesh basket, suspended on or supported by the frame, can be immersed into and removed from a hot oil bath. Such baskets have been used for years and are nearly ubiquitous in restaurants and food service institutions.

A problem with prior art wire baskets is the susceptibility of the wire mesh basket to physical damage. Because the mesh basket's sides and corners are also made of wire mesh, leaving them unprotected means they can be bent or dented if the basket is dropped or is otherwise not handled properly. A wire fry basket that protects the wire mesh basket's sides and wire mesh corners would be an improvement over the prior art.

### SUMMARY

An improved wire fry basket has a wire mesh basket into which foods to be fried are placed. Horizontal edges of the relatively fine wire mesh basket, i.e., the top and horizontal edges located at the bottom of the basket, are protected by upper and lower rigid wire frames. The vertical corners, however, are only partially protected by relatively short lengths rigid wire that extend upwardly from corners of the lower rigid wire frame protecting the bottom or lower, horizontal edges of the wire mesh basket.

### BRIEF DESCRIPTION OF THE FIGURES

FIG. 1 is a left side view of an in-frame wire fry basket having shortened, corner-protecting wires;

FIG. 2 is a right side view of the basket shown in FIG. 1;

FIG. 3 is a front end view of the basket shown in FIG. 1;

FIG. 4 is a rear view of the basket shown in FIG. 1;

FIG. 5 is a perspective view of the basket looking into the basket from behind and above the rear of the basket;

FIG. 6 is a left side view of an alternate embodiment of the in-frame wire fry basket;

FIG. 7 is a right side view of the basket shown in FIG. 6;

FIG. 8 is a front end view of the basket shown in FIG. 6;

FIG. 9 is a rear view of the basket shown in FIG. 6;

FIG. 10 is a top view of the basket shown in FIG. 6;

FIG. 11 is a bottom view of the basket shown in FIG. 6; and

FIG. 12 is a perspective view of the basket.

### DETAILED DESCRIPTION

FIG. 1 is a left side view of a first embodiment of an in-frame wire fry basket 10 with shortened, corner-protecting wires 12. FIG. 2 is a right side view of the basket 10. FIG. 3 is a front view and FIG. 4 is a rear view showing how the handle 14 is attached to the basket 10. For clarity purposes, the terms, “in-frame wire fry basket with shortened, corner-protecting wires,” “wire fry basket,” “wire basket,” “fry basket” and “basket” are hereafter used interchangeably.

The fry basket 10 is comprised of four inclined sides 18, 20, 22, and 24 and a bottom 26, all of which are formed from a relatively fine-gauge wire mesh material, well known in the fry basket prior art. The basket 10 has an open top 28, best seen in FIG. 5, the shape of which is rectangular or at least substantially rectangular and which allows foods to be placed into and taken out of the basket 10.

The sides 18, 20, 22, and 24 are inclined relative to vertical such that the sides 18, 20, 22, and 24 diverge away from each other providing the open top 28 with length and width dimensions greater than the length and width dimensions of the bottom 26. The sides' shapes are therefore trapezoidal. A trapezoid is considered herein to be a quadrilateral having only two sides parallel to each other.

Two similarly-shaped rigid wire frames 30, 32, support the mesh sides 18, 20, 22, and 24 and bottom 26 and connect the sides 18, 20, 22, and 24 and bottom 26 to the handle 14, which is also made from rigid wire. The upper frame 30 and the lower frame 32 that support and protect the wire mesh material are both substantially rectangular and their shapes similar. The upper frame 30, however, is larger than the lower frame 32.

The frames 30, 32 each have two, parallel long sides and two parallel short sides. The short sides and long sides are orthogonal to each other and joined or meet each other at the four corners 34, 36 of each frame.

Since the open top 28 is rectangular or at least substantially rectangular, the width dimension 38 (See FIG. 3.) of the open top 28 is of course greater than the length dimension 40 (See FIGS. 1 and 2.) of the open top 28. Since the sides are trapezoids, inclined relative to vertical and since opposing panels diverge away from each other, the width and length dimensions 42, 44 of the bottom 26 are less than the width and length dimensions 38, 40 of the open top 28.

The wire mesh from which the sides and bottom are made can be a relatively large sheets stamped to form the sides and bottom. A length of wire mesh material can also be wound or wrapped around a form to form the sides to which the bottom is attached. Or, five separate “sheets” of wire mesh can be attached to each other to form the four inclined sides and bottom.

Regardless of the method used to form wire mesh into an inverted, truncated pyramidal shape that results from having four inclined sides 18, 20, 22, and 24 and a bottom 26 attached to each other as shown in the figures are considered herein as “meeting” at four inclined and upright wire-mesh corners 46 and four horizontal wire mesh corners 48. The inclined and upright corners 46 are formed where the inclined sides 16, 18, 20 and 22 meet each other. The horizontal corners are formed where the sides 16, 18, 20 and 22 “meet” the wire mesh bottom 26.

The inclined corners 46 coincide with the corners formed into both upper and lower rectangular frames, 34 and 36 respectively. Stated another way, the inclined corners 46, which are formed by the intersection, joinder or formation of outwardly-tilting inclined wire mesh sides 16, 18, 20 and 22, are aligned with and correspond to the corners 34 of the rectangular upper frame 30 and the corners 36 of the rectangular lower frame 32.

Close inspection of the figures shows that the rectangular upper frame 30 is sized such that the wires forming the upper frame are outside and therefore surrounding the rectangular open top 28. On the other hand, the rectangular lower frame is sized such that the wires forming the lower frame 32 are located below the four horizontal corners 48.

As best seen in FIG. 4, the fry basket 10 is provided with two short, corner-reinforcing wire segments 12, which are attached to and extend upwardly from the lower rear corners 36 of the lower rigid wire frame 32. The corner-reinforcing rigid wire segments 12 are shortened, which means they do not extend all the way to the upper frame 30 but instead extend only part way up from the lower frame 32 toward the upper frame 30. Stated another way, each of the sides 16, 18, 20, and 22 has an inclined height 52 between the two frames, however, the corner-reinforcing rigid wire segment 12 has a vertical length 54 that is a fraction of the inclined height 52. In a preferred embodiment, the shortened, corner-reinforcing rigid wire segment 12 has an actual, inclined height of about one inch. Alternate embodiments of the fry basket 10 however have shortened corner-protecting wires 12 with heights ranging between about one-half inch up to about four inches.

Empirical data shows that providing corner-reinforcing rigid wires that extend completely between the top frame and the bottom frame is unnecessary since most corner-deforming impacts take place at or near the two lower rear corners of the basket. Reducing the height (or length) of the corner-reinforcing rigid wire segments 12 and providing them at only two corners of the lower frame reduces the weight and cost as compared to prior art in-frame wire baskets that have full-length corner-reinforcing wires.

Still referring to FIG. 4, the corner-reinforcing rigid wire segments 12 can be seen to be attached to opposite ends of a short wire segment 57 of the bottom rigid wire frame 32 located at the rear side of the lower rigid wire frame 32. The shortened corner-reinforcing wire extend upwardly a short distance, preferably about one inch, to where both of the shortened corner-reinforcing wire segments bend horizontally and inwardly to form shortened horizontal segments 56. The horizontal segments 56 extend toward each other but do not reach each other or the middle of the basket. Rather they bend upwardly and form part of the ergonomic handle 14, as can be seen in FIG. 4 and FIG. 5. Stated another way, the rigid wire forming the shortened corner-protecting segments 12 extend upwardly about an inch to protect the wire-mesh corners 46 but the rigid wire also forms part of the rigid wire handle 14 by having the left and right segments bend inwardly, toward each other to where the wire segments can be bent upwardly to join the wire handle 14.

The wire mesh panels, i.e., the wire mesh sides 16, 18, 20, 22 and bottom 26, form a wire mesh basket having a shape equal to or reminiscent of an inverted pyramid, which also is sliced or truncated through a plane parallel to the pyramid's base. Such a shape is well-known as a frusto-pyramid because it is the shape of a pyramid that remains after the pyramid is cut or truncated along a plane parallel to the pyramid's base.

The wire mesh basket, which comprises the sides 16, 18, 20, 22 and bottom 26 is considered herein to be an inverted frusto-pyramid but nevertheless frusto-pyramidal. The frust-pyramidal-shaped wire mesh basket is sized and shaped to fit within, i.e., between the upper and lower frames and “in front of” the first and second corner segments described above.

As best seen in FIG. 5, the upper frame 30 and lower frame 32 are both comprised of long side wires that oppose each other and which are orthogonal to short side wires. The upper frame 30 has an inside dimension between the long side wires that is greater than the distance between the wide sides of the wire basket. The upper frame has a second inside dimension between the short side wires which is also greater than the distance between the small wire mesh sides of the wire mesh basket.

Since the lower frame 32 is rectangular or substantially rectangular it has first and second long side wires that oppose each other and first and second short side wires that oppose each other. Unlike the dimensions of the upper frame 30, the dimensions of the lower frame 32 are selected such that the horizontal corners 48 formed where the wire mesh bottom 26 meets the inclined wire mesh sides 16, 18, 20, 22, lie directly above or nearly directly above the rigid wires forming the long and short sides of the lower frame 32. The lower frame thus supports the wire mesh “basket” formed of the wire mesh sides and bottom panels.

FIGS. 6-11 are views of an alternate embodiment of a wire fry basket. FIG. 6 is a left side view, FIG. 7 is a right side view, FIG. 8 is a front view and FIG. 9 is a rear view of an alternate embodiment of an in-frame wire fry basket 100 with shortened, corner-protecting wires. FIGS. 10 and 11 are top and bottom views respectively.

As with the basket shown in FIGS. 1-5, the fry basket 100 shown in FIGS. 6-119 has four inclined wire mesh sides 18, 20, 22, and 24, which meet to form four inclined corners 46: two front corners 46a and two inclined rear corners 46b. The fry basket 100 also has a wire mesh bottom 26, which meets with the inclined wire mesh sides to form horizontally-oriented corners 48. The fry basket 100 also has an open top 28, the shape of which is rectangular or at least substantially rectangular and which allows foods to be placed into and taken out of the basket 100.

Unlike the basket 10 shown in FIGS. 1-5, which has shortened corner-protecting wires 12 at the two rear inclined corners 46, the basket 100 shown in FIGS. 6-9 has shortened corner-protecting wires 120 at the two front inclined corners 46a as well as shortened, corner-protecting wires 12 at the two rear inclined corners 46b. All four corners 46a, 46b formed by the wire mesh sides 18, 20, 22 and 24 are thus protected by relatively short, rigid wires 12, 120.

As best seen in FIG. 8, the front corners 46a of the alternate embodiment fry basket 100 is provided with two, shortened, substantially vertical corner-reinforcing wire segments 120 having a height 122, which is preferably the same as the height 54 described above for the two shortened corner-reinforcing wires 12 for the rear corners 46b.

The front corner reinforcing wires 120 extend upwardly from the bottom 26 of the basket 100 by the aforementioned height 122 then bend inwardly toward each other by way of a horizontal wire frame section 124, which connects the two front corner reinforcing wires 120 to each other.

As with the basket shown in FIGS. 1-5, the front corner-reinforcing rigid wire segments 120 are shortened, which means they do not extend all the way to the upper frame 30 but instead extend only part way up from the lower frame 32 toward the upper frame 30. Stated another way, each of the sides 16, 18, 20, and 22 has an inclined height 52 between the two frames 30 and 32, however, the corner-reinforcing rigid wire segments 12 and 120 have vertical lengths 54 and 122 respectively, which are a fraction of the inclined height 52. In the alternate embodiment of the fry basket 100, the shortened, corner-reinforcing rigid wire segments 12 and 120 have an actual, inclined height of about one inch. Other alternate embodiments of the fry basket 100 however have shortened corner-protecting wires 12 and 120 with heights ranging between about one-half inch up to about four inches.

Those of ordinary skill in the art will recognize that by reducing the amount of rigid wire used to reinforce or protect the corners of a wire mesh basket, considerable weight and material can be saved making the basket easier to use and less expensive to manufacture. Those of ordinary skill in the art will also recognize that the in-frame baskets 10 and 100 can be used with oil, water and other liquids. Finally, those of ordinary skill will also recognize that the length of the shortened corner-protecting wires 12, 120 in both embodiments can also vary widely, ranging between about ten percent of the basket side's inclined height up to about two-thirds of the basket side's inclined height with the preferred height being about one inch.

The foregoing description is for illustration purposes only. The true scope of the invention is set forth in the following claims.

What is claimed is:

1. An in-frame wire basket comprising:
four substantially rectangular inclined sides joined to each other to form an inverted frusto-pyramid and which are formed from wire mesh, each inclined side having a first inclined height;
a substantially rectangular bottom formed from wire mesh and joined to the four inclined sides;
a substantially rectangular open top;
four inclined wire mesh corners extending between the wire mesh bottom and the substantially rectangular open top and having the first inclined height;
four horizontal wire mesh edges formed by and located where the wire mesh bottom meets the inclined wire mesh sides;
a substantially-rectangular, rigid-wire upper frame having four sides and four corners corresponding to the four inclined corners, the upper frame being located adjacent to, outside and surrounding the substantially rectangular open top;
a substantially-rectangular, rigid wire lower frame located below the wire mesh bottom, the lower frame having four sides located below the four horizontal corners, the lower frame having four sides and four corners located below and adjacent the four inclined corners of the basket formed from wire mesh;
a first, corner-reinforcing rigid wire segment attached to and extending upwardly from a first corner of the lower frame by a distance equal to a first fraction of the first inclined height, the first corner-reinforcing rigid wire segment being configured to protect the first fraction of the first inclined height from corner-deforming impacts; and
a second, corner-reinforcing rigid wire segment attached to and extending upwardly from a second corner of the lower frame by a distance equal to a second fraction of the first inclined height, the second corner-reinforcing rigid wire segment being configured to protect the second fraction of the first inclined height from corner-deforming impacts.

2. The wire basket of claim 1 wherein, the first and second, corner-reinforcing rigid wire segments are attached to first and second corners of the lower rigid wire frame and are laterally adjacent to each other.

3. The wire basket of claim 1, wherein the four inclined corners extending between the wire mesh bottom and the substantially rectangular open top define two front corners and two rear corners and wherein first and second, corner-reinforcing rigid wire segments are located at two front corners.

4. The wire basket of claim 1, wherein the four inclined corners extending between the wire mesh bottom and the substantially rectangular open top define two front corners and two rear corners and wherein first and second, corner-reinforcing rigid wire segments are located at two rear corners.

5. The wire basket of claim 1, wherein the four inclined corners extending between the wire mesh bottom and the substantially rectangular open top define two front corners and two rear corners, the wire basket further comprising:
a third shortened corner-reinforcing rigid wire segment attached to and extending upwardly from a third corner of the lower frame by a distance equal to a first fraction of the first inclined height, the third corner-reinforcing rigid wire segment being configured to protect the first fraction of the first inclined height from corner-deforming impacts; and
a fourth shortened corner-reinforcing rigid wire segment attached to and extending upwardly from a fourth corner of the lower frame by a distance equal to a second fraction of the first inclined height, the fourth corner-reinforcing rigid wire segment being configured to protect the second fraction of the first inclined height from corner-deforming impacts;
whereby each of the four inclined corners is provided with a shortened, corner-reinforcing wire.

6. The wire basket of claim 2, further comprising an ergonomic wire handle attached to a first side of the upper frame and to a corresponding first side of the lower frame.

7. The wire basket of claim 6, wherein the first side of the lower frame is a side of the lower frame between the first and second corners of the lower frame.

8. The wire basket of claim 6, wherein the first and second fractions of the first inclined height are substantially the same and wherein the fractions of the first inclined height are between about one-half inch and about four inches.

9. The wire basket of claim 8, wherein the first and second fractions of the first inclined height are substantially the same and wherein the fractions of the first inclined height are between about three-quarters of an inch and about two-inches.

10. The wire basket of claim 6, wherein the first, corner-reinforcing rigid wire segment comprises a first portion having a first end attached to the first corner of the lower frame and a second end located above the first end by said first fraction of the first inclined height, the first corner-reinforcing rigid wire segment additionally comprising a second portion extending from the second end of the first portion to the ergonomic wire handle.

11. The wire basket of claim 6, wherein the second, corner-reinforcing rigid wire segment comprises a first portion having a first end attached to the second corner of the lower frame and a second end located away from the first end by said second fraction of the first inclined height, the second corner-reinforcing rigid wire segment additionally comprising a second portion extending from the second end of the first portion to the ergonomic wire handle.

12. The wire basket of claim 6, wherein the second portions of the first and second corner-reinforcing rigid wire segments are inclined along a first inclined side of the basket and form part of the ergonomic wire handle.

13. The wire basket of claim 6 wherein the rigid wire handle is comprised of at least four, substantially co-planar rigid wire sections.
